(19) United States
(12) Patent Application Publication
(10) Pub. No.: US 2004/0008377 A1
(43) Pub. Date: Jan. 15, 2004

(54) Method for adding a text to an image

(76) Inventors: Stone Cheng, Kaohsiung (TW); Chung-Wei Cheng, Hsinchu (TW); Mei-Cheng Ho, Kaohsiung (TW)

Correspondence Address: BIRCH STEWART KOLASCH & BIRCH, PO BOX 747, FALLS CHURCH, VA, 22040-0747, US

(21) Appl. No.: 10/331,982

(22) Filed: Dec. 31, 2002

(30) Foreign Application Priority Data
Jul. 9, 2002 (TW) 091115260

(51) Int. Cl. H04N 1/387; G06K 15/00

(52) U.S. Cl. 358/1.18; 358/450

(57) ABSTRACT

A method for adding text to an image applied to an image scanner including at least the following steps: first, pre-scan a document and acquire a source image accordingly; next, input the content of the text to be added to the source image such that the source image becomes a pre-set image; last, perform document-scanning according to the pre-set image to acquire a scanned image. Of which, the text content can be located at any position of the pre-set image, whereas the source image and the pre-set image can be displayed via a display interface. In practice, the display interface can be a display window.

This application incorporates by reference Taiwan application Serial No. 091115260, filed Jul. 9, 2002.

### BACKGROUND OF THE INVENTION

1. Field of the Invention

The invention relates in general to an image processing method, and more particularly to an image processing method applied to an image scanner.

2. Description of the Related Art

Among so many peripheral devices of the personal computer, the image scanner is a very basic piece of equipment.

Please refer to FIG. 1, a flowchart according to a conventional image-scanning method of an image scanner. The conventional method includes the following steps. First, start a driver at step 110. Next, at step 120, the driver starts a scanning module of the scanner to pre-scan the document to be scanned which is placed on the scanning platform to acquire a source image. After that, go to step 130 where the scanner scans the document to be scanned according to the source image. Last, at step 140, finish document scanning, and acquire a scanned image.

However, the above conventional image scanning method can only produce a scanned image having the image of the document alone: it cannot add any extra text to a document image. Therefore, the user has to resort to other methods if he or she wants to add extra text to a document image.

As was stated above, the conventional image scanning method has the disadvantage of failing to supply the document image with extra explanatory text. Some images of the documents scanned need to be assisted by explanatory texts. Nevertheless, the conventional image scanning method does not provide such a text-added function to a document image.

### SUMMARY OF THE INVENTION

It is therefore an object of the invention to provide a method for adding a text to an image. The purpose is to allow extra text to be added to a document image.

The invention achieves the above-identified objects by providing a new method for adding a text to an image. The features of the method are briefed as follows. A method for adding text to an image which is applied to an image scanner including at least the following steps: first, pre-scan a document and acquire a source image accordingly; next, input the content of the text to be added to the source image such that the source image becomes a pre-set image; last, perform document-scanning according to the pre-set image to acquire a scanned image. Of which, the text content can be located at any position of the pre-set image, whereas the source image and the pre-set image can be displayed via a display interface. In practice, the display interface can be a display window.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1, a flowchart of process shows a conventional image-scanning method of an image scanner;

FIG. 2, a flowchart of process shows an image-scanning method according to a preferred embodiment of the invention which adds a text to an image;

FIG. 3, a block diagram shows an image-scanning method according to a preferred embodiment of the invention with or without added text being displayed on a pre-set image;

FIG. 4A, a location diagram of an image-scanning method according to a preferred embodiment of the invention which allows added text to be displayed on a scanned image; and

FIG. 4B, another location diagram of an image-scanning method according to a preferred embodiment of the invention which allows the added text to be displayed on a scanned image.

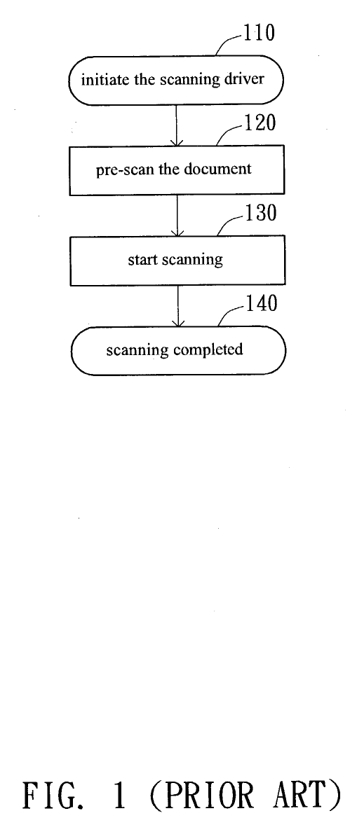

### DETAILED DESCRIPTION OF THE INVENTION

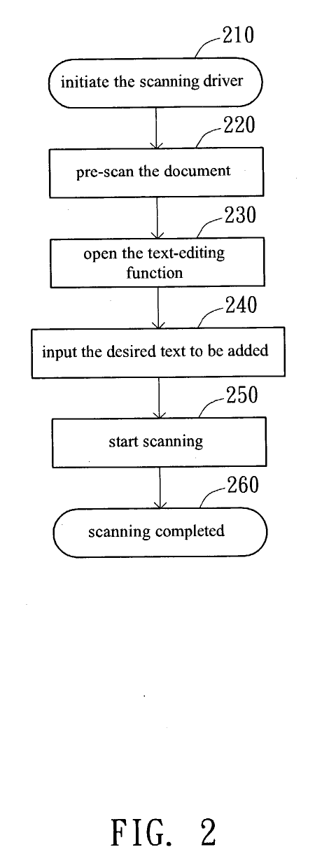

Referring first to FIG. 2, a flowchart of process shows an image-scanning method according to a preferred embodiment of the invention which adds a text to an image. The method according to the invention includes the following steps. First, initiate the driver program at step 210. Next, at step 220, the driver starts a scanning module of the scanner to pre-scan the document to be scanned which is placed on the scanning platform to acquire a source image. After that, at step 230, the user opens the text-editing function according to his or her needs. Following that, input the content of the text desired to be added to the source image such that the source image becomes a pre-set image. Then, at step 250, the scanner scans the document to be scanned according to the pre-set image. Last, at step 260, finish document scanning, and a text-added image will be acquired.

In the above stated method, both the source image and the pre-set image can be displayed via a display interface. The display interface can be, for instance, a display window with a movable cursor.

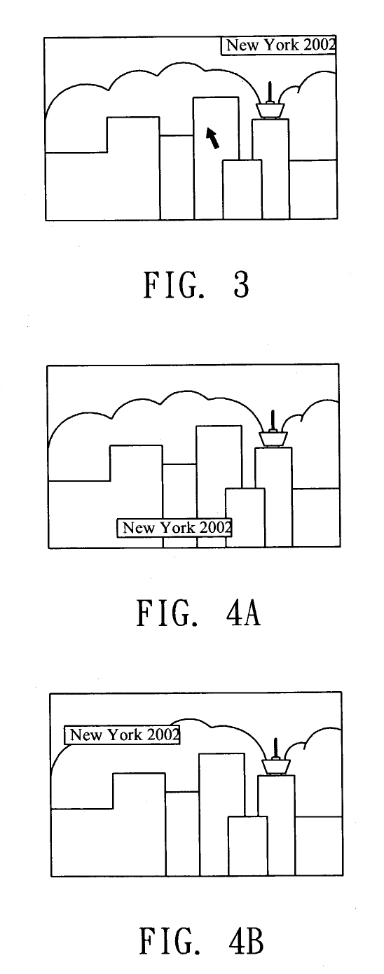

Please refer to FIG. 3, a block diagram which shows an image-scanning method according to a preferred embodiment of the invention with or without the added text being displayed on a pre-set image. That is to say, following step 240, the content of the text inputted can be displayed on the pre-set image via a display window by shifting the movable cursor to the pre-set image. Otherwise, the content of the text will not be displayed on the pre-set image if the cursor is moved away from the pre-set image. It is noteworthy that the purpose of having the text content displayed on the display window or not is just for the user's convenience to check whether any texts have been added to the pre-set image and what the contents are. It does not influence whether the content of the text can be displayed on the scanned image or not. However, the content of the text will eventually be displayed on the scanned image provided the text-editing function has been opened and the text content has been inputted.

FIG. 4A, a location diagram of an image-scanning method according to a preferred embodiment of the invention which allows added text to be displayed on a scanned image, whereas FIG. 4B shows another location diagram of an image-scanning method according to a preferred embodiment of the invention which allows added text to be displayed on a scanned image. The added text in FIG. 4A and in FIG. 4B are at different positions which are determined by the user.

Therefore, the invention allows explanatory text to be added to a scanned image. In some occasions, the scanned image of a document needs to be assisted by an explanatory text. The text-adding method for adding a text to an image according to the invention provides the function to add the content of a text to a scanned image.

The image text-adding method disclosed in the above preferred embodiments of the invention allows extra text to be added to the image of a document scanned.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for adding text to an image applied in an image scanner, comprising the steps of:
pre-scanning a document and acquire a source image according to the document;
inputting the content of the text to be added to the source image such that the source image becomes a pre-set image; and
scanning the document according to the pre-set image to acquire a scanned image.

2. The method according to claim 1, wherein the content of the text can be located at any position of the scanned image.

3. The method according to claim 2, wherein the source image and the pre-set image can be displayed via a display interface.

4. The method according to claim 3, wherein the display interface is a display window with a movable cursor.

5. The method according to claim 4, wherein, after inputting, the content of the text inputted will be displayed on the pre-set image if the cursor is moved to the pre-set image, and the content of the text inputted will not be displayed on the pre-set image if the cursor is moved away from the pre-set image.
